(19) United States
(12) Patent Application Publication
(10) Pub. No.: US 2003/0017396 A1
(43) Pub. Date: Jan. 23, 2003

(54) Anode compositions for use in alkaline cells, zinc alloy powders to make up said anode compositions, and alkaline cells using said anode compositions

(75) Inventors: Kenichi Harigae, Akita-shi (JP); Masayuki Nishina, Honjo-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: DOWA MINING CO., LTD., Tokyo (JP)

(21) Appl. No.: 10/167,285

(22) Filed: Jun. 11, 2002

(30) Foreign Application Priority Data
Jun. 11, 2001 (JP) 2001-176083

(51) Int. Cl. H01M 4/42; H01M 4/62; C22C 18/00; C22C 18/04

(52) U.S. Cl. 429/229; 429/217; 420/514; 420/519; 420/513

(57) ABSTRACT

A zinc alloy containing Al, Bi and In is reduced to particles by gas atomization and sieved to prepare a zinc alloy powder. A polyacrylic acid powder and a magnesium hydroxide powder are added to the zinc alloy powder and the ingredients are mixed to make an anode composition. Zinc oxide is added to an aqueous KOH solution to prepare a liquid electrolyte which is mixed with the anode composition under stirring to make a gelled anode composition that has improved performance in pulsed discharge to get large current without increasing the evolution of hydrogen gas.

### BACKGROUND OF THE INVENTION

This invention relates to anode compositions having improved performance in pulsed discharge under a heavy load. The invention also relates to zinc alloy powders to make up such anode compositions, as well as alkaline cells using such anode compositions.

Alkaline cells, in particular, alkaline manganese cells (MnO₂/KOH/Zn) show better discharge performance than conventional Leclanché cells and manganese cells that use acidic electrolytes, so they are extensively used in miniature primary cells in button and cylindrical shapes If it comes to use in portable devices such as toys and cameras that need discharge under a heavy load, economy is another advantage of alkaline cells, so an increasing share of the market for miniature primary cells has been taken by alkaline cells. The recent years are seeing a growing use of portable devices that require discharge under a heavier load as exemplified by digital cameras and PDAs and alkaline manganese cells are also used to supply power to such devices. For LR06 type cell, attempts have been made to satisfy the requirement for performance in heavy-load discharge, particularly the need of digital cameras for getting large current instantaneously and this has arisen an increased need to improve the performance of active anode materials or compositions in discharge under a heavy load.

The prior art method proposed by JP 59-42779 A comprises mixing magnesium hydroxide and polyacrylic acid with water (at a pH near 7), drying the mix and coating the surfaces of zinc particles with the dried mix. A problem with this technique is that oxidation of zinc progresses during the drying step to increase the evolution of hydrogen gas. As another problem, a large amount of Mg is dissolved in the near neutral range and crosslinking of the gel proceeds to such an extent that an adequate amount of electrolyte cannot be retained near the zinc particles; this results in deteriorated cell characteristics because a local shortage of electrolyte during pulsed discharge cannot be corrected by an adequate supply of the electrolyte.

A common practice in the prior art for improving the heavy-load discharge performance of cell materials is reducing the particle size of the active material in powder form or optimizing its particle size distribution so as to increase the area of contact between the electrolyte and the active material, namely, to increase the area of reaction by a sufficient degree to reduce resistances against reaction such as activation polarization and concentration polarization.

Similar approaches are taken in the field of anodes in alkaline cells, as shown in JP 53-120143 A, JP 57-182972 μl JP 58-12254 A and WO 99/07030. According to JP 57-182972 A, coarse zinc particles of 70-500 μm are mixed with fine zinc particles of 25 μm or less in an amount of 5-30 wt % of the total of the zinc powder and the mix is subsequently processed to prepare a gel of zinc anode having improved performance in heavy-load discharge and higher utilization. In WO 99/07030, a coarse zinc powder is mixed with two grades of fine powder (−200 mesh and −325 mesh) and it teaches that the higher the proportion of the fine powder, the better the performance in 0.25 W continuous discharge and pulsed discharge under a heavy load.

However, these approaches which intend to increase the area of reaction have turned out to be incapable of achieving satisfactory improvements in characteristics in a mode as experienced by digital cameras where pulsed discharge is effected to produce large current in a short time. As another problem, if the area of reaction increases, the active anode material undergoes an accelerated self-discharge reaction which leads to the evolution of hydrogen gas at an increasing rate. This is a trade-off between improved discharge characteristics under a heavy load and reduced safety due to the increasing speed of hydrogen gas evolution.

### SUMMARY OF THE INVENTION

An object, therefore, of the present invention is to provide an anode composition for use in alkaline cells that has improved performance in pulsed discharge to get large current without increasing the evolution of hydrogen gas.

Another object of the invention is to provide a zinc alloy powder for use in the anode composition.

Yet another object of the invention is to provide an alkaline cell using the anode composition.

The present inventors conducted intensive studies in order to attain these objects and found that by adding a specified amount of a magnesium hydroxide powder to an anode composition in either a gelled and/or ungelled form, the performance of the anode composition in pulsed discharge to get large current could be markedly improved without increasing the evolution of hydrogen gas.

### BRIEF DESCRIPTION OF THE DRAWING

FIG. 1 shows a vertical section of a device for measuring the amount of hydrogen gas evolved.

FIG. 2 shows a vertical section of a LR06 type cell.

### DETAILED DESCRIPTION OF THE INVENTION

The present invention provides the following gelled anode compositions for use in alkaline cells.

1. A gelled anode composition for use in alkaline cells which comprises at least a zinc alloy powder, a gelling agent and an aqueous alkali solution and which further contains a magnesium hydroxide powder in an amount of 0.01-0.2 wt % of said zinc alloy powder.

2. The gelled anode composition according to item 1, wherein said gelling agent is a carboxyl-containing gelling agent and brought into contact with said magnesium hydroxide powder in an aqueous solution having a pH of at least 10.

3. The gelled anode composition according to item 1 or 2, wherein said zinc alloy powder contains 0.01-0.1 wt % of In and 0.005-0.1 wt % of at least one element selected from the group consisting of Al, Bi, Mg and Ca, with the balance being incidental impurities and zinc.

4. An alkaline cell using the gelled anode composition according to any one of items 1-3.

5. A zinc alloy powder to make up the gelled anode composition according to item 1 or 2 which contains 0.01-0.1 wt % of In and 0.005-0.1 wt % of at least one element selected from the group consisting of Al, Bi, Mg and Ca, with the balance being incidental impurities and zinc.

The mechanism behind the advantages that are brought about by the invention has not been fully elucidated but the following hypothetical model may be postulated. Before discharge, the magnesium hydroxide present within the anode gel or on the surfaces of zinc alloy particles occurs as a porous aggregate of fine particles several tens of nanometers in size which holds the electrolyte either in its interior or on its surface. If there occurs a local shortage of electrolyte in areas such as those near the surfaces of zinc alloy particles on account of quick discharge such as pulsed discharge to get large current, the retained electrolyte is released to improve the performance in pulsed discharge.

The solubility of magnesium hydroxide in aqueous solution increases with decreasing pH of the solution. Therefore, if a pH drop occurs during pulsed discharge to get large current on account of a rapid consumption of hydroxyl ions (OH⁻) near the surfaces of zinc alloy particles, magnesium hydroxide might dissolve out to supply additional hydroxyl ions.

As noted in JP 59-42779 A, carboxyl-containing gelling agents such as polyacrylates are known to undergo a highly accelerated polymerization reaction in the presence of divalent metal ions. The solubility of magnesium hydroxide in highly alkaline aqueous solutions is very small but during the aging period after cell fabrication, the magnesium ion might dissolve out of the magnesium hydroxide dispersed in the anode gel and accelerate the crosslinking reaction of the carboxyl-containing gelling agent to form a polymer compound as an aggregate. Probably, this aggregate incorporates the electrolyte before discharge and in a electrolyte depleting situation like pulsed discharge to get large current, the aggregate releases the electrolyte to improve the discharge performance.

In the present invention, the magnesium hydroxide powder is added in an amount of 0.01-0.2 wt % of the zinc alloy powder. If its addition exceeds 0.2 wt %, the viscosity of the anode composition in gel form increases so much that difficulty is involved in filling a cell container with the gel. If the addition of the magnesium hydroxide powder is less than 0.01 wt %, there is no improvement in cell characteristics.

The gelling agent preferably contains carboxyl groups and polyacrylic acid is more preferred. To secure ease in the gel filling operation, the preferred range for the addition of polyacrylic acid is between 0.9 and 1.1 wt % of the zinc alloy powder. If less than 0.9 wt % of polyacrylic acid is added, a slurry rather than a gel forms. If more than 1.1 wt % of polyacrylic acid is added, difficulty is involved in the filling operation because of decreased fluidity.

The magnesium hydroxide powder has preferably a specific surface area of no more than 20 m²/g as measured by the BET method. Beyond 20 m²/g, moisture absorption and carbonation progress in the magnesium hydroxide powder during storage to such an extent that when it is added to the zinc alloy powder, the discharge performance of the anode composition deteriorates.

The method of producing a gelled anode composition containing magnesium hydroxide is not limited in any particular way but the following three may be mentioned.

(1) A zinc alloy powder, a magnesium hydroxide powder, a gelling agent, an organic and/or inorganic additive are mixed together to prepare an anode composition which in turn is mixed with an aqueous alkali solution having zinc oxide dissolved therein, whereby a gelled anode composition is made; the gelling agent and the organic and/or inorganic additive may optionally be added to the aqueous alkali solution having zinc oxide dissolved therein.

(2) A zinc alloy powder, a gelling agent and an organic and/or inorganic additive are mixed together to prepare an anode composition which in turn is mixed with an alkaline slurry having a magnesium hydroxide powder added to an aqueous alkali solution having zinc oxide dissolved therein, whereby a gelled anode composition is made; the gelling agent and the organic and/or inorganic additive may optionally be added to the alkaline slurry.

(3) A zinc alloy powder, a gelling agent and an organic and/or inorganic additive are mixed together to prepare an anode composition which in turn is mixed with an alkali electrolyte having zinc oxide dissolved therein, whereby a gelled anode composition is made; thereafter, a magnesium hydroxide powder is added to the gelled anode composition and mixed therewith; the gelling agent and the organic and/or inorganic additive may optionally be added to an alkaline slurry.

The gelling agent may be selected from among known compounds such as starches, cellulosic derivatives, polylacrylates and ethylene-maleic anhydride copolymers. Care must be taken when carboxyl-containing gelling agents are used and they are preferably mixed with magnesium hydroxide in aqueous solution at a pH of at least 10. If the carboxyl-containing gelling agent is mixed with magnesium hydroxide in an aqueous solution at a pH of less than 10, the magnesium ion dissolves into the aqueous solution in such a great amount that the crosslinking reaction of the gelling agent is accelerated and the intended improvement of performance in pulsed discharge to get large current is not achieved; in addition, the viscosity of the gelled anode composition increases so much as to present difficulty in filling a cell container with the gel.

As a prior art technology using magnesium hydroxide, JP 59-42779 A discloses a process for producing an alkaline cell which comprises mixing a zinc alloy powder, magnesium hydroxide and polyacrylic acid, adding water to the mixture under agitation so that polyacrylic acid reacts with the magnesium ion, whereby part or all of the polyacrylic acid is converted to a magnesium salt, and forming a coat of the gelling agent around the zinc alloy particles. According to JP 59-42779 A, the alkaline cell produced by this method has improved performance in discharge under a light load and better low-temperature characteristics. However, as will be shown later in the Comparative Examples, this prior art technology turned out to exhibit deteriorated rather than improved performance in a pulsed discharge mode to get large current (the discharge mode contemplated by the invention) and it also increased the evolution of hydrogen gas.

Considering productivity, a preferred method of adding magnesium hydroxide is by mixing a zinc alloy powder first with a magnesium hydroxide powder and/or the powder of a gelling agent, then with an electrolyte.

The zinc alloy powder to be used in the invention has preferably an average particle size of 100-300 μm. Below 100 μm, the proportion of fines increases and on account of the increased surface area of the zinc powder, more hydrogen gas evolves to increase the chance of electrolyte leakage and cell bursting. A zinc alloy powder having an average particle size in excess of 300 μm is difficult to produce by gas atomization without reducing the yield.

Any known zinc alloy powders may be used in the invention but in order to suppress the evolution of hydrogen gas, it is preferred to use a zinc alloy powder containing 0.01-0.1 wt % of In and 0.005-0.1 wt % of at least one element selected from the group consisting of Al, Bi, Mg and Ca, with the balance being incidental impurities and zinc. Outside this compositional range, the evolution of hydrogen gas will increase.

The following examples are provided for the purpose of further illustrating the present invention but are in no way to be taken as limiting.

### EXAMPLE 1

A zinc alloy containing 0.003 wt % Al, 0.015 wt % Bi and 00.05 wt % In was reduced to particles by gas atomization and passed through a 35-mesh screen to make a zinc alloy powder having an average particle size no larger than 425 μm. To this zinc alloy powder, 1 wt % of a polyacrylic acid powder and 0.01 wt % of a magnesium hydroxide powder were added and the ingredients were mixed together to prepare an anode composition.

In a separate step, 3 wt % of zinc oxide was added to a 40 wt % aqueous KOH solution to prepare a liquid electrolyte. The electrolyte was mixed with the anode composition under agitation to make a gelled anode composition. Measurement with a Brookfield viscometer showed that the gelled anode composition had a viscosity of 403 Pa·S.

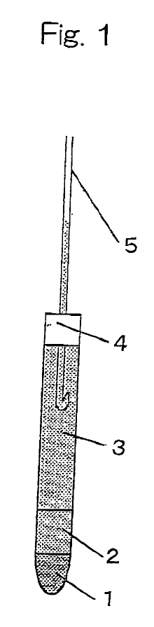

A sample of the gelled anode composition was put into a device of the type shown in FIG. 1 and held there at 60° C. for 3 days to determine the rate of evolution of hydrogen gas (μl/g·day). In FIG. 1, numeral 1 designates the zinc alloy powder, 2 is the electrolyte, 3 is liquid paraffin, 4 is a silicon stopper, and 5 is a measuring pipette.

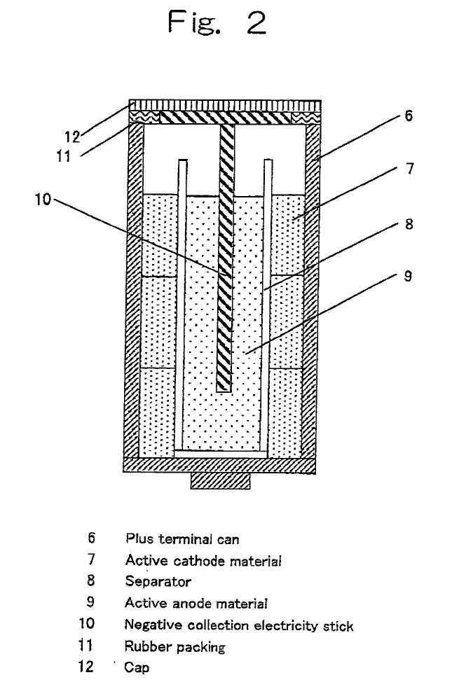

Using the gelled anode composition, LR06 cells were fabricated and their performance in discharge under a heavy load was measured on a 1.2 A pulsed discharge test (3-sec discharge and 7-sec rest). FIG. 2 shows a vertical section of a LR06 type cell, in which numeral 6 designates the plus terminal can, 7 is the active cathode material, 8 is the separator, 9 is the active anode material, 10 is the negative collection electricity stick, 11 is the rubber packing and 12 is the cap. In the 1.2 A pulsed discharge test, the time of amperage retention until voltage dropped to 1.0 V or 0.9 V was measured. The result was expressed in relative values, with the time of amperage retention in the cell of Comparative Example 1 (see below) being taken as 100; the comparative cell was fabricated using the same zinc alloy powder as indicated above but without incorporating a magnesium hydroxide powder. The internal resistance of the cell was 0.065 Ω. The result is shown in Table 1 below.

Results of Measurement of Gas Evolution and Discharge Performance

| | Anode composition | | | | | Contact | | | | | |
|---|---|---|---|---|---|---|---|---|---|---|---|
| | | | | Average | | between | | | | | |
| | Composition of | | | particle | | gelling | | | | Cell performance | |
| | zinc alloy | | | size of | Addition | agent | Gelled anode composition | | | Pulsed discharge | |
| | powder | | | zinc alloy | of | and | Gelling | Gas | | 1 Vcut | 0.9 Vcut |
| | Al | Bi | In | powder | Mg(OH)₂ | Mg(OH)₂ | agent | evolution | Viscosity | Relative | Relative |
| | ppm | ppm | ppm | μm | wt % | pH | wt % | μl/g · day | Pa · s | value (%) | value (%) |
| Example 1 | 30 | 150 | 500 | 134 | 0.01 | 15 | 1 | 14.8 | 403 | 102 | 104 |
| Example 2 | 30 | 150 | 500 | 134 | 0.05 | 15 | 1 | 13.3 | 525 | 112 | 113 |
| Example 3 | 30 | 150 | 500 | 134 | 0.1 | 15 | 1 | 15.0 | 420 | 131 | 110 |
| Example 4 | 30 | 150 | 500 | 134 | 0.2 | 15 | 1 | 14.3 | 525 | 113 | 108 |
| Example 5 | 30 | 125 | 500 | 190 | 0.05 | 15 | 1 | 13.0 | 355 | 114 | 110 |
| Example 6 | 30 | 150 | 500 | 134 | 0.05 | 10 | 1 | 19.6 | 315 | 109 | 109 |
| Comparative | 30 | 150 | 500 | 134 | 0 | 15 | 1 | 16.5 | 374 | 100 | 100 |
| example 1 | | | | | | | | | | | |
| Comparative | 30 | 150 | 500 | 134 | 0.5 | 15 | 1 | 14.8 | >525 | 98 | 99 |
| example 2 | | | | | | | | | | | |
| Comparative | 30 | 150 | 500 | 134 | 0.05 | 7 | 1 | 22.1 | 303 | 70 | 82 |
| example 3 | | | | | | | | | | | |
| Comparative | 30 | 150 | 500 | 134 | MgO 0.05 | 15 | 1 | 14.5 | 350 | 52 | 72 |
| example 4 | | | | | | | | | | | |
| Comparative | 30 | 150 | 500 | 134 | MgCO₃ 0.05 | 15 | 1 | 15.1 | 329 | 66 | 84 |
| example 5 | | | | | | | | | | | |

### EXAMPLE 2

An alkaline cell (LR06 type cell) was fabricated and evaluated as in Example 1 except that 0.05 wt % of magnesium hydroxide was added to the zinc alloy powder. The result is shown in Table 1.

### EXAMPLE 3

An alkaline cell was fabricated and evaluated as in Example 1 except that 0.1 wt % of magnesium hydroxide was added to the zinc alloy powder. The result is shown in Table 1.

### EXAMPLE 4

An alkaline cell was fabricated and evaluated as in Example 1 except that 0.2 wt % of magnesium hydroxide was added to the zinc alloy powder. The result is shown in Table

### EXAMPLE 5

An alkaline cell was fabricated and evaluated as in Example 1, except that a zinc alloy containing 0.003 wt % Al, 0.0125 wt % Bi and 0.05 wt % In was reduced to particles by gas atomization and passed through a 35-mesh screen and a 200-mesh screen to make a zinc alloy powder comprising particles ranging from 75 to 425 μm in size and that the amount of the magnesium hydroxide powder added to the zinc alloy powder was increased to 0.05 wt %. The result is shown in Table 1.

### COMPARATIVE EXAMPLE 1

A zinc alloy containing 0.003 wt % Al, 0.015 wt % Bi and 0.05 wt % In was reduced to particles by gas atomization and passed through a 35-mesh screen to make a zinc alloy powder having an average particle size no larger than 425 μm. The zinc alloy powder was gelled by adding polyacrylic acid and a 40% KOH electrolyte without using magnesium hydroxide. Using the gelled anode composition, a cell was fabricated and measured for discharge characteristics and gas evolution. The result is shown in Table 1.

### COMPARATIVE EXAMPLE 2

An alkaline cell was fabricated and evaluated as in Example 1 except that 0.5 wt % of magnesium hydroxide was added to the zinc alloy powder. The result is shown in Table 1.

### COMPARATIVE EXAMPLE 3

A zinc alloy containing 0.003 wt % Al, 0.015 wt % Bi and 0.05 wt % In was reduced to particles by gas atomization and passed through a 35-mesh screen to make a zinc alloy powder having an average particle size no larger than 425 μm. To this zinc alloy powder, 1 wt % of polyacrylic acid and 0.05 wt % of a magnesium hydroxide powder were added and the ingredients were mixed together to prepare an anode composition (1). To the stirred anode composition (1), 1.5 wt % of pure water was added dropwise and the mixture was dried at 45° C. for 1 hour to make an anode composition (2). An alkaline cell was fabricated and evaluated as in Example 1 except for using the anode composition (2). The result is shown in Table 1.

### COMPARATIVE EXAMPLE 4

An alkaline cell was fabricated and evaluated as in Example 2 except that 0.05 wt % of magnesium oxide rather than magnesium hydroxide was added to the zinc alloy powder. The result is shown in Table I.

Comparison with the result of Example 2 shows that the use of magnesium oxide was not at all effective in improving the cell performance in pulsed discharge.

### EXAMPLE 6

An alkaline cell was fabricated and evaluated as in Comparative Example 4 except that a −1.5 wt % aqueous KOH solution with a pH of 10 was added dropwise to the anode composition (1) under stirring. The result is shown in Table 1.

Comparing Examples 2 and 6 with Comparative Example 3, one can see that there was no improvement of cell performance in pulsed discharge unless the pH of the aqueous solution in which the zinc alloy powder and magnesium hydroxide were brought into contact with the carboxyl-containing gelling agent was at least 10.

### COMPARATIVE EXAMPLE 5

An alkaline cell was fabricated and evaluated as in Example 2 except that 0.05 wt % of magnesium carbonate rather than magnesium hydroxide was added to the zinc alloy powder. The result is shown in Table 1.

Comparison with the result of Example 2 shows that the use of magnesium carbonate was not at all effective in improving the cell performance in pulsed discharge.

According to the invention, there is provided an anode composition having improved performance in pulsed discharge to get large current without increasing the evolution of hydrogen gas. The invention also provides a zinc alloy powder to make up the anode composition and an alkaline cell using the anode composition.

What is claimed is:

1. A gelled anode composition for use in alkaline cells which comprises at least a zinc alloy powder, a gelling agent and an aqueous alkali solution and which further contains a magnesium hydroxide powder in an amount of 0.01-0.2 wt % of said zinc alloy powder.

2. The gelled anode composition according to claim 1, wherein said gelling agent is a carboxyl-containing gelling agent and brought into contact with said magnesium hydroxide powder in an aqueous solution having a pH of at least 10.

3. The gelled anode composition according to claim 1 or 2, wherein said zinc alloy powder contains 0.01-0.1 wt % of In and 0.005-0.1 wt % of at least one element selected from the group consisting of Al, Bi, Mg and Ca, with the balance being incidental impurities and zinc.

4. An alkaline cell using the gelled anode composition according to claim 1 or 2.

5. An alkaline cell using the gelled anode composition according to claim 3.

6. A zinc alloy powder to make up the gelled anode composition according to claim 1 or 2 which contains 0.01-0.1 wt % of In and 0.005-0.1 wt % of at least one element selected from the group consisting of Al, Bi, Mg and Ca, with the balance being incidental impurities and zinc.
